(19) United States
(12) Patent Application Publication
(10) Pub. No.: US 2003/0217661 A1
(43) Pub. Date: Nov. 27, 2003

(54) Sleeve for flexographic printing having hard deformable outer layer

(76) Inventor: Christian Schnieders, Velen (DE)

Correspondence Address: Killworth, Gottman, Hagan & Schaeff, L.L.P., Suite 500, One Dayton Centre, Dayton, OH, 45402-2023, US

(21) Appl. No.: 10/434,030

(22) Filed: May 8, 2003

(30) Foreign Application Priority Data
May 8, 2002 (DE) 202 07 243 U

(51) Int. Cl. B41F 13/10

(52) U.S. Cl. 101/376

(57) ABSTRACT

A sleeve for flexographic printing is provided and includes an inner layer, a compressible layer over the inner layer, and an outer layer having a rigid surface over the compressible layer. The outer layer and the compressible layer are adapted to interact such that the outer layer is deformable radially inwardly under the loads occurring during the printing operation.

### BACKGROUND OF THE INVENTION

This invention relates to a sleeve for use in flexographic printing, and more particularly to such a sleeve that may be used as an adapter sleeve or a support for an imagable layer such as a flexographic printing plate or sleeve.

In a typical flexographic printing process, a flexographic printing plate is attached to a cylinder, and as the cylinder rotates, the inked plate provides an image onto a substrate carried on an impression drum. The art conventionally provides the printing plate in the form of a printing sleeve that is expandable by air pressure for mounting and demounting onto the print cylinder. Typical flexography presses operate at high speeds, sometimes printing over 600 linear feet of paper per minute. These high printing speeds require that the print cylinders and sleeves also rotate at high speeds. The construction of the printing cylinders and printing sleeves can vary, and different constructions have been used to attempt to optimize their printing performance.

As known in the art, the diameter of the inner surface of an air-mounted printing sleeve must be slightly smaller than the diameter of the outer surface of the printing cylinder. The difference in these diameters is a dimension known as the interference fit. Moreover, the diameter of the inner surface of the printing sleeve must be expandable by the provision of pressurized air between the opposed surfaces of the sleeve and the printing cylinder in order to mount such printing sleeves onto the printing cylinders as well as remove the sleeves therefrom.

Also in flexographic printing, it is well known to design sleeves having comparatively greater wall thicknesses so that the inner layer of the sleeve is expandable, while the diameter of the outer layer remains essentially unchanged. For this purpose, an inner layer or layers are provided which are comparatively hard so as to withstand mechanical loads encountered during assembly and disassembly of the sleeve. However, such inner layers are expandable due to the presence of a compressible layer positioned radially outside of the hard inner layer that permits expansion of the inner layer.

The outer layers of such flexographic printing sleeves are comprised of relatively soft, compressible layers that accommodate “hard” glued printing plates. Alternatively, it is known to provide comparatively hard outer layers onto which the printing plates are then “soft” glued (i.e., adhered using a compressible foam having a pressure sensitive adhesive on both sides thereof). In both instances, the desire is to provide a flexible support for the flexographic printing plate so that peak pressures that can occur between the printing plate and the substrate to be printed are avoided.

Where the printing plate is “hard” glued, for instance, typically only a 0.1 mm thick adhesive layer is provided to attach the printing plate to the flexible outer layer of the printing sleeve. Where the plate is “soft” glued to a hard outer layer, typically a foam adhesive tape having a thickness of greater than about 0.5 mm to up to several millimeters may be used.

In order to provide precise printing results it is desirable to facilitate the flexibility of the printing plate in order to avoid the aforementioned undesirable high peak pressures which can occur between the printing plate and the substrate to be printed. On the other hand, however, the prior art practices may result in undesirable variations in the soft outer layer of the sleeve or the soft adhesive layer used to adhere the plate, resulting in poor quality printing.

Also known in the art are printing sleeves where the outer layer is adjusted through the use of a hard material and/or employing greater layer thickness so that the outer layer will not deform during the printing operation.

Busshoff, U.S. Pat. Nos. 6,276,271, 6,360,662, and 6,467,409 (commonly-assigned) are directed to bridge mandrels that are adapted to fit onto a cylinder. A flexographic printing sleeve is then expanded and fitted onto the bridge mandrel. The mandrel is constructed to include a rigid inner layer of fiber reinforced polymer, an intermediate layer of rigid or compressible polyurethane foam, and a compressible out surface layer. A series of air channels and orifices permit the mandrel to be slipped onto an existing print cylinder.

There remains a need in this art for a sleeve that is capable of supporting a plate for flexographic printing, each facilitating a preferably high printing precision with a preferably sturdy design.

### SUMMARY OF THE INVENTION

The present invention meets that need by providing a sleeve for use in flexographic printing that may be used as an adapter sleeve or a support for an imagable layer such as a flexographic printing plate or sleeve. In accordance with one aspect of the invention, a sleeve for flexographic printing is provided. The sleeve comprises an inner layer, a compressible layer over the inner layer, and an outer layer having a rigid surface over the compressible layer. The outer layer and the compressible layer are adapted to interact such that the outer layer is deformable radially inwardly under the loads occurring during the printing operation. As used herein, the term “over” refers to a layer or structure formed above or in contact with a surface or layer, and the term “on” refers to a layer or structure formed in contact with a surface or layer.

In a preferred form, the sleeve further includes an intermediate layer of a non-compressible material that is arranged between the inner layer and the compressible layer. The sleeve may further include a second compressible layer that is arranged between the inner layer and the intermediate layer and a support layer on the second compressible layer. Preferably, the support layer is impermeable to gases.

The sleeve may also include a flexographic printing plate that is secured to the rigid surface of the outer layer. In a preferred form, the printing plate is secured with a thin layer of a substantially non-compressible adhesive. Alternatively, the sleeve may also include an imagable coating layer on the hard surface of the outer layer. The imagable coating layer may comprise a laser-engravable material or a curable photopolymer material.

In another embodiment of the invention, the combination of a flexographic printing sleeve and an adapter sleeve is provided. The printing sleeve includes an imagable surface, and the adapter sleeve comprises an inner layer, a compressible layer over the inner layer, and an outer layer having a rigid surface over the compressible layer. The printing sleeve, the outer layer, and the compressible layer are adapted to interact such that the printing sleeve and the outer layer are deformable radially inwardly under the loads occurring during the printing operation.

In a preferred form the adapter sleeve further includes an intermediate layer of a non-compressible material that is arranged between the inner layer and the compressible layer and/or a second compressible layer that is arranged between the inner layer and the intermediate layer. The adapter sleeve may also include a support layer on the second compressible layer that is impermeable to gases.

The imagable surface may comprise a separate layer that is secured to the printing sleeve with a thin layer of a substantially non-compressible adhesive. Alternatively, the imagable surface may comprise a layer of photocurable polymeric material.

Accordingly, it is a feature of the present invention to provide a sleeve for use in flexographic printing that may be used as an adapter sleeve or a support for an imagable layer such as a flexographic printing plate or sleeve facilitating a preferably high printing precision with a preferably sturdy design. These and other features and advantages of the invention will become apparent from the following detailed description, the accompanying drawing, and the appended claims.

### BRIEF DESCRIPTION OF THE DRAWING

FIG. 1 is a view, partially in section, of one embodiment of the printing sleeve of the present invention.

### DETAILED DESCRIPTION OF THE PREFERRED EMBODIMENTS

In one embodiment, a sleeve having a hard outer layer is provided, with the outer layer being impressible by a compressible layer arranged beneath it. For this purpose, the outer layer has a correspondingly suitable layer thickness and/or is fabricated from a suitable material to ensure that the hard outer layer is deformed under the loads occurring during the printing operation despite the desired hard material character of the outer layer. As a result of the compressible layer positioned beneath the outer layer being deformed, a larger-area of deformation of the outer layer, instead of a merely selective deformability, can take place so that the desired hard material character of the outer layer can be maintained while still providing its deformability. Therefore, the outer layer deforms to a lesser degree by a selective compliance, possibly even reducing its layer thickness at the point of compression load, by the formation of a dent and/or truncation of its radius under compression of the compressible layer.

In this way the sleeve will, advantageously, be particularly sturdy because, compared to foamed compressible outer layers used in the prior art, for instance, a hard outer layer can better withstand mechanical loads. Due to the deformability of the hard outer layer, work can be carried out with a thin, hard, (i.e. not intentionally compressible) adhesive tape to attach a printing plate to the sleeve. In this way a particularly accurate and precise positioning of the printing plate is possible because the variable tolerances of using a compressible adhesive layer do not occur. The positive influencing of the printing properties by the radial impressability and/or radial compliance of the printing plate is made possible with a sleeve according to certain embodiments of the invention.

Unlike the usual design principles for flexographic printing, the printing plate is not attached to the sleeve “hard on soft” or “soft on hard”, i.e. either with a hard adhesive to a soft sleeve surface or with a soft adhesive to a hard sleeve surface. Surprisingly, improved print quality is obtained using a “hard on hard” configuration, i.e. with a hard, not significantly compressible adhesive to a, likewise, hard sleeve surface. If necessary, the printing plate can also be created on the sleeve surface without an adhesive by coating the outer layer with an imagable material, and by subsequently engraving, lasing, or photopolymerizing the printing surface and possibly washing out material residues.

The sleeve can have substantial wall thicknesses, it being possible to use a, preferably, lightweight material to form an intermediate layer. In this manner, particularly great wall thicknesses, e.g. from 5 mm to 10 or more centimeters may be achieved. The intermediate layer is provided between the inner layer and the compressible layer. Where the nature of the materials used in the intermediate layer do not make it possible to expand the inner layer, two compressible layers of the same or different materials can be provided, one of which adjoins the inner layer and the other adjoins the outer layer, in each instance to enable their respective deformation.

A support layer may optionally be provided for the inner compressible layer adjoining the inner layer. The support layer affords a good separation between the inner compressible layer any adjacent layer. For example, if an open-cell foam material is used for the inner compressible layer, the support layer prevents material subsequently applied when making the sleeve from running into the open pores of the compressible layer. This avoids adversely affecting the compression properties of the compressible layer.

Particularly if during fabrication of the sleeve a material is applied onto the compressible layer, e.g. as an intermediate layer, which will cure under the development of heat, the formation of undesired blisters in the intermediate layer which could result due to gas evolutions from the compressible layer can be prevented by arranging the supporting layer as a gas tight (i.e., gas impermeable) layer between the compressible layer and an adjacent layer. This gas barrier effect can be advantageous for both open-cell and closed-cell materials used for the compressible layer.

The sleeves built up in this manner are suitable for flexographic printing by securing or forming the printing plate directly on the sleeve. To do so, the printing plate can be adhered to the outer layer of the sleeve, preferably not using a foam tape having adhesive thereon, but using a thin and “hard” adhesive in so far as this adhesive is essentially non-compressible.

Alternatively, especially for the printing of endless patterns, provisions may be made to coat the outer surface of the sleeve with a material from which the printing plate is to be made. These materials may be engravable or those capable of being “lased” in a manner well known in the art. Because such a coating is applied to the outer layer, it is non-compressibly joined with the outer layer, i.e. there is no compressible material between this coating and the outer layer so that the desired “hard” character with which the printing plate is arranged on the outer layer is achieved.

While the sleeve may be fabricated to include a printing plate on the outer layer the sleeve, it is also possible to create a two-part sleeve using the combination of a printing sleeve and an adapter sleeve whose inside diameter is adapted to the outside diameter of the desired printing cylinder. The adapter sleeve may be designed in accordance with embodiments of the invention. Because of its hard outer layer, the sleeve provides a trouble-free assembly with the printing sleeve component. That is, there is trouble-free mounting and dismounting of the outer sleeve onto the adapter sleeve as compared with a prior art adapter sleeve having a soft outer layer which, experience shows, typically offers a considerably higher frictional resistance.

With such a printing sleeve having a two-part design consisting of an adapter sleeve and an outer sleeve, the outer sleeve is designed to deform with the outer layer of the adapter sleeve so that both sleeve components, under compression of the compressible layer adjacent to the outer layer of the adapter sleeve, can be deformed in the above described manner under the loads occurring in printing operation. The desired hard-on-hard printing character can be ensured by a corresponding material selection of the outer print sleeve, e.g. by the use of a glass fibre reinforced plastic where the desired deformability of the outer layer of the adapter sleeve can be ensured through the use of a correspondingly thin wall thickness.

Similar to the above described integral printing sleeves, it is also possible to ensure the “hard” surface character of the outer layer of the print sleeve either through the use of a thin and non-compressible, i.e. “hard,” adhesive between the printing plate and the sleeve or by coating an imagable material onto the sleeve with the material provided as the printing plate for a two-part printing sleeve combination.

Reference will now be made by way of example to an embodiment of the invention as will be explained in greater detail by reference to the accompanying diagrammatic drawing.

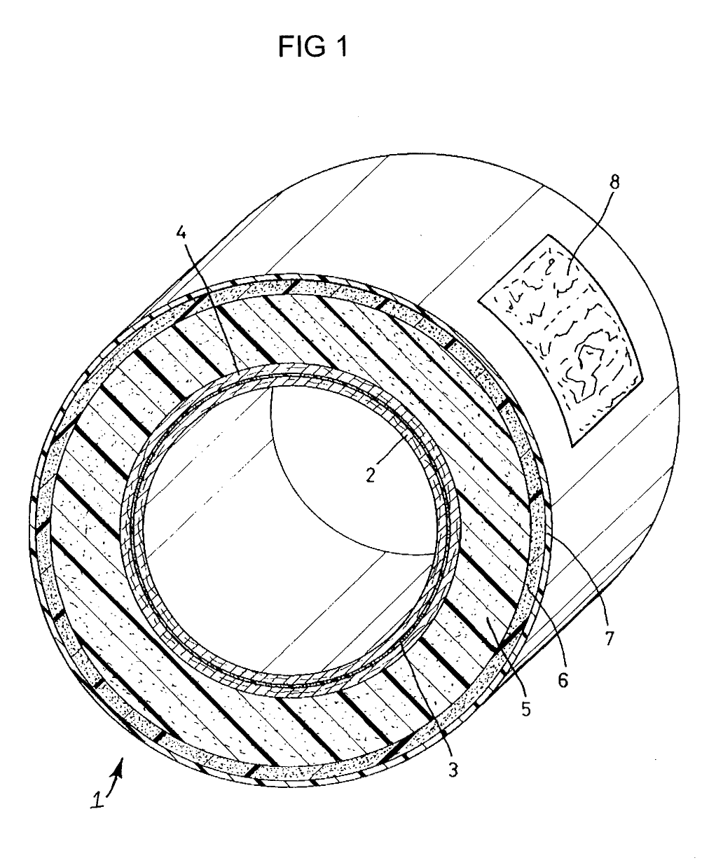

FIG. 1 shows a printing sleeve for use in flexographic printing. The sleeve, collectively designated as 1, includes an inner layer 2 made, for example, of glass fiber reinforced plastic. Inner layer 2 is hard, i.e. not significantly compressible and, in particular, “surface hard,” i.e., wear resistant, so that it can withstand the different assembly and disassembly operations that are required without any problems.

Inner layer 2, however, is elastically deformable, especially radially extensible, when placed under pressure. Inner layer 2 expands to compress compressible layer 3 that is positioned over layer 2, and on layer 2 in the illustrated embodiment. Typically, compressible layer 3 comprises an open-cell foam material. A further layer 4 of glass fiber reinforced plastic is positioned over compressible layer 3, and on layer 3 in the illustrated embodiment. Layer 4 provides support to compressible layer 3 as well as protecting the porous foam material of compressible layer 3. That is, when fabricating the sleeve 1, support layer 4 prevents the pores of compressible layer 3 from filling up during subsequent coating steps for the build-up of the multi-layer sleeve wall and, thus, prevents a reduction of the compressibility of layer 3. In addition, layer 4 acts as a gas tight barrier layer.

Above supporting layer 4 there is provided an intermediate layer 5 which, like layer 3, comprises a foam material but which, unlike compressible layer 3, is not designed as a compressible layer but as a hard layer. The use of a hard foam material for intermediate layer 5 enables the use of greater wall thicknesses for sleeve 1 to keep rotary inertia forces of sleeve 1 during printing as small as possible. It is also possible to use a different lightweight material instead of a foam material for the intermediate layer 5, e.g. by placing lightweight fillers into the base material of intermediate layer 5.

An additional compressible layer 6 is provided over support layer 4. Compressible layer 6 is also made of a foam material similar to the material used for inner compressible layer 3. This additional outer compressible layer 6 serves to make hard outer layer 7 deformable under the pressure loads typically encountered during printing. Intermediate layer 5 and outer layer 7 can comprise, basically, the same material or type of material. Intermediate layer 5 is foamed and/or provided with lightweight fillers for the weight reasons mentioned, whereas the same material may be used for outer layer 7 in an unfoamed and/or unfilled condition in order to provide outer layer 7 with the desired harness and durability.

A printing plate 8 is indicated diagrammatically as positioned on outer layer 7, the adhesive layer between printing plate 8 and outer layer 7 being so thin that it is not shown in the drawing. At any rate, no provisions have been made for an intentional compression effect by the adhesive layer.

By way of example only, the diagrammatically represented embodiment of the invention may be fabricated as follows:

The overall diameter of sleeve 1 is approximately 12 cm, and the free inside diameter is approximately 7 cm. This enables mounting of sleeve 1 on a printing cylinder or an adapter sleeve of corresponding diameter. Inner layer 2 is made from glass fiber reinforced resin and is approximately 1 mm thick. Compressible layer 3 is also approximately 1 mm thick. Supporting layer 4 may, likewise, be fabricated of glass fiber reinforced resin and is approximately from 1-1.5 mm thick. Intermediate layer 5 comprises polyurethane filled with lightweight fillers and is approximately 18 mm thick. The outer additional compressible layer 6 is approximately 2 mm thick. Outer layer 7 comprises unfilled polyurethane, e.g. the same polyurethane material which, when filled, is used for intermediate layer 5. Outer layer 7 is from about 1-2 mm thick.

While outer layer 7 can have a hardness of approximately 70-80 Shore D in order to create a sturdy and cuttable surface layer of the sleeve on which printing plates or adhesive tapes can be cut with knives, the outer additional compressible layer 6 can have a hardness of approximately 20-60 Shore AS, e.g. 30 Shore A, in order to be sufficiently compressible and to provide outer layer 7 with a capability of deforming under pressures encountered during printing operations.

Intermediate layer 5, which principally determines the wall thickness of sleeve 1, can be considerably thinner than indicated in the illustrated embodiment. However, it can also be considerably thicker, e.g. several centimeters thick, if a large repeat for a print job is needed and the printing cylinder is of a relatively small diameter. Where only relatively small wall thicknesses are required for sleeve 1, supporting layer 4 and/or intermediate layer 5 can be omitted, if appropriate.

While sleeve 1 as illustrated represents a printing sleeve by the printing plate 8 provided on its surface, provision might also be made, in an alternative to the embodiment shown, for sleeve 1 to be used without a printing plate. For example, the sleeve may be used as an adapter sleeve for diameter compensation, whose inside diameter is adapted to fit onto a printing cylinder and whose outside diameter is adapted to accept an outer sleeve which, for its part, carries a printing plate. It is only by the mounting of the outer sleeve on the adapter sleeve that the printing sleeve is created in this way, the wall thickness and/or the material character of the outer sleeve being adapted to the deformability provided, e.g. by the use of a glass fiber reinforced resin sleeve with a wall thickness of 0.5 mm or less, and sleeve 1 having a softer and/or thinner outer layer than shown in the drawing for use as an adapter sleeve.

While certain representative embodiments and details have been shown for purposes of illustrating the invention, it will be apparent to those skilled in the art that various changes in the methods and apparatus disclosed herein may be made without departing from the scope of the invention, which is defined in the appended claims.

What is claimed is:

1. A sleeve for flexographic printing, said sleeve comprising an inner layer, a compressible layer over said inner layer, and an outer layer having a rigid surface over said compressible layer, said outer layer and said compressible layer being adapted to interact such that said outer layer is deformable radially inwardly under the loads occurring during the printing operation.

2. A sleeve as claimed in claim 1 further including an intermediate layer of a non-compressible material is arranged between said inner layer and said compressible layer.

3. A sleeve as claimed in claim 2 further including a second compressible layer that is arranged between said inner layer and said intermediate layer.

4. A sleeve as claimed in claim 3 further including a support layer on said second compressible layer.

5. A sleeve as claimed in claim 4 in which said support layer is impermeable to gases.

6. A sleeve as claimed in claim 1 further including a printing plate that is secured to said rigid surface of said outer layer.

7. A sleeve as claimed in claim 6 in which said printing plate is secured with a thin layer of a substantially non-compressible adhesive.

8. A sleeve as claimed in claim 1 further including an imagable coating layer on said hard surface of said outer layer.

9. A sleeve as claimed in claim 8 in which said imagable coating layer comprises a laser-engravable material.

10. A sleeve as claimed in claim 8 in which said imagable coating layer comprises a curable photopolymer.

11. In combination a flexographic printing sleeve and an adapter sleeve, said printing sleeve including an imagable surface, and said adapter sleeve comprising an inner layer, a compressible layer over said inner layer, and an outer layer having a rigid surface over said compressible layer, said printing sleeve, said outer layer, and said compressible layer being adapted to interact such that said printing sleeve and said outer layer are deformable radially inwardly under the loads occurring during the printing operation.

12. A combination as claimed in claim 11 further including an intermediate layer of a non-compressible material that is arranged between said inner layer and said compressible layer.

13. A combination as claimed in claim 12 further including a second compressible layer that is arranged between said inner layer and said intermediate layer.

14. A combination as claimed in claim 13 further including a support layer on said second compressible layer.

15. A combination as claimed in claim 14 in which said support layer is impermeable to gases.

16. A combination as claimed in claim 11 in which said imagable surface comprises a separate layer that is secured to said printing sleeve with a thin layer of a substantially non-compressible adhesive.

17. A combination as claimed in claim 11 in which said imagable surface comprises a layer of photocurable material.
